(19) United States
(12) Patent Application Publication
(10) Pub. No.: US 2004/0080936 A1
(43) Pub. Date: Apr. 29, 2004

(54) Christmas decoration lamp holder

(76) Inventor: Chih-Chen Chang, Hsinchu City (TW)

Correspondence Address: CHARLES E. BAXLEY, P.C., 5th Floor, 59 John Street, New York, NY, 10038, US

(21) Appl. No.: 10/281,436

(22) Filed: Oct. 28, 2002

(51) Int. Cl. H01R 33/00

(52) U.S. Cl. 362/226

(57) ABSTRACT

The present invention relates to a Christmas decoration lamp holder, and more particularly to a holding frame, in which the lamp can be rapidly plugged in without pre-setting the bulb and pre-locating the conducting strips. Thereby, setting the retaining slots on the outside wall of bulb base facilitates that the conducting strips can be assembled by hands; and the conducting strips placed at outside wall of the bulb base are pressed to the inside of the retaining slots by the first clamping blocks tightly, so that, when the bulb is placed into the bulb base and the wires is hung over the surface of the conducting strips respectively through the notches of the elastic clamping tongues, after putting on the holding sheath over the bulb base in plug connection, the wires of the bulb are pressed on the surfaces of the conducting strips tightly by the first clamping blocks to form conduction state. Meanwhile the second clamping blocks push the clamping tongues to clamp the bulb tightly. In this way, during the assembling process the hands of the operator can freely operate to arrange the components in place and to assemble them without pre-setting the bulb and pre-locating the conducting strips any more, just need one time to assemble all to save the assembling time and much improving the passing rate.

### BACKGROUND OF THE INVENTION

1. Field of the Invention

The present invention relates to a Christmas decoration lamp holder, and more particularly to a holding frame, in which the lamp can be rapidly plugged in without pre-setting the bulb and pre-locating the conducting strips.

2. Description of Prior Art

For setting off the festival atmosphere by contrast, a lot of Christmas decoration lamps are claimed in market, so in the worldwide there are several million new lamp strings manufactured by the factories for meeting the necessary, but during past several decades the manufacturing and assembling ways has not had any great change. The Christmas decoration lamp is a labor-intensive product, so improving the speed of assembling and reducing the rejection rate have became a vital method of controlling production cost.

In accordance with the conventional Christmas decorating lamp, as shown in FIG. 11, it includes a bulb core base 5′ having a bulb housing (not shown); as setting the bulb into the lamp holder 2′, firstly wire the two wires 111′ of the bulb through out two side holes at the bottom of said bulb housing respectively, and bend back upward against the outside wall of said bulb core base 5′ for use. The lamp holder 2′ is a hollow sheath, in which the upper portion is used for embedding said bulb core base 5′, coordinating to it, two power cords 3′ are led out from the bottom end of said lamp holder 2′ at the top side, and connected with two conducting strips 31′ respectively, then drag down the cords 3′ to make the both conducting strips 31′ slide down along the opposite inside walls of said lamp holder 2′ until locating the two conducting strips 31′ in the retaining slots 124 respectively. When plugging the assembled bulb core base 5′ into the lamp holder 2′, the bulb wires 111′ stuck on the outside wall of said bulb core base 5′ contact with said conducting strips 31′ so as to cut on the power to light the bulb 11′.

But during a long time practicing, some shortcomings of the conventional mechanism on the assembling process are exposed out, and affect the production cost:

1. Because the wires 111′ of the conventional Christmas decoration lamp's bulb 11′ are so fine that they are wired through a narrow bulb housing and the two fine pin holes 51′ one by one, and bent back after passing out, all the processing not only take much assembling time, but also easy to happen the both wires 11′ entering one hole 51′ mistake, or the bent wires 111′ located in out of proper positions so that they can not contact with the conducting strips correctly, further to make the bulb 11′ lost power.

2. As trying to locate the conducting strips at the ends of said cords 3′ into the inside retaining slots 124′ of said lamp holder 2′ by dragging down the cords 3′, due to the limitation of narrow space at the inside of said lamp holder 2′, the finger is unable to stretch on giving any assistance, all the operation has to be finished just only depending on the experience under blind operation, hence some mistakes like out of place and require repeating assembling may happen in high ratio so as to waste much time.

### OBJECTS AND SUMMARY OF THE INVENTION

It is therefore a main object of the present invention to provide a decoration lamp holding frame, in which the lamp can be rapidly plugged in without pre-setting the bulb and pre-locating the conducting strips.

The another object of the present invention is to provide a decoration lamp holding frame, in which the wires of the bulb can be kept into a good contacting condition with said conducting strips.

These objects are achieved by a Christmas decoration lamp holding frame consisted of a bulb base and holding sheath, in which the bulb base includes two portions-upper portion and low portion; said upper portion has a bulb housing at the top center, along the rim of the bulb housing there is at least one pair of elastic clamping tongues extended upward and central-ward, and the adjacent clamping tongues are kept out a certain space to form a notch, and the diameter of the circle surrounded by the tips of the clamping tongues is a bit smaller than the bulb's; below the opposite notches there are a couple of retaining slots formed respectively for holding said conducting strips, and the width of said retaining slot is a bit smaller than or equal the conducting strip's; below the retaining slots a pair of cord grooves formed downward for embedding the power cords respectively;

Said holding sheath is a hollow cylinder with a complementary inside shape with outside shape of said bulb base to form the first clamping blocks coordinating to the retaining slots and the second clamping blocks coordinating to the clamping tongues of the upper portion of said bulb base; for achieving to clamping function the distance between two opposite the first clamping blocks should be a bit smaller than or equal the outside diameter of said retaining slots; the diameter surrounded by the second clamping blocks should be a bit smaller or equal the clamping tongue's.

Said cord grooves built on said bulb base are built to the center at the low portion of the bulb base to form a pair of windows so that they are divided at the low portion to the out sides upward respectively through them.

Said retaining slot of said bulb base is extended a pair of gullet teeth vertically along the outside edges to form a sliding slot on said retaining slot.

Said retaining slot has tilt sides appearing into wider up and narrow bottom.

There is a stopper between said bulb base and said holding sheath axially.

Said bulb base has a pair of opposite lugs at the bottom side in radial, coordinating to the lugs said holding sheath has a pair of notches for housing the lugs.

Due to applying above-mentioned mechanism, setting the retaining slots on the outside wall of bulb base facilitates that the conducting strips can be assembled by hands; and the conducting strips placed at outside wall of the bulb base are pressed to the inside of the retaining slots by the first clamping blocks tightly, so that, when the bulb is placed into the bulb base and the wires is hung over the surface of the conducting strips respectively through the notches of the elastic clamping tongues, after putting on the holding sheath over the bulb base in plug connection, the wires of the bulb are pressed on the surfaces of the conducting strips tightly by the first clamping blocks to form conduction state. Meanwhile the second clamping blocks push the clamping tongues to clamp the bulb tightly. In this way, during the assembling process the hands of the operator can freely operate to arrange the components in place and to assemble them without presetting the bulb and pre-locating the conducting strips any more, just need one time to assemble all to save the assembling time and much improving the passing rate.

Said retaining slot has a pair of gullet teeth formed at the vertical opening edges to the inside to form a sliding slot for guiding the conducting strip sliding into the inside of the retaining slot and locating in there, or widening the top open widely to form upper wider and bottom narrow for guiding and locating the conducting strip even if the cords are dragged under an extra force.

The depth of the retaining slot should be proper bigger than the thickness of the conducting strip, so that the wire of the bulb is not escaped from the contacting range of the conducting strip as clamping under the first clamping block.

Between the bulb base and the holding sheath a gearing stopper is built so that the jack-socket joint is made smooth and tight.

Said bulb base has a pair of symmetrical lugs built upon the bottom side, and the holding sheath has a pair of coordinating notches at coordinating places for housing the lugs, thereby facilitating holding of hands as separating the sheath and the bulb base.

### BRIEF DESCRIPTION OF THE DRAWINGS

FIG. 1 is an exploded solid view showing the first embodiment of the present invention.

FIG. 2 is an exploded view showing the first embodiment of the present invention.

FIG. 3 is a solid view showing the assembled bulb base without covering the holding sheath of the first embodiment of the present invention.

FIG. 4 is a solid view showing the combined state of the first embodiment of the prior art.

FIG. 5 is an exploded view showing the second embodiment of the present invention.

FIG. 6 is an exploded view showing the second embodiment of the present invention.

FIG. 7 is an exploded view showing the assembled bulb base without covering the holding sheath of the second embodiment of the present invention.

FIG. 8 is a solid view showing the combined second embodiment of the present invention.

FIG. 9 is an exploded view showing the assembled bulb base without covering the holding sheath of the third embodiment of the present invention.

FIG. 10 is a solid view showing the fourth embodiment of the present invention.

FIG. 11 is a sectional view of the prior art.

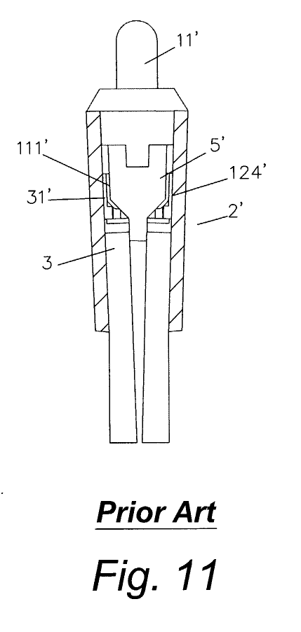

### DETAILED DESCRIPTION OF PREFERRED EMBODIMENTS

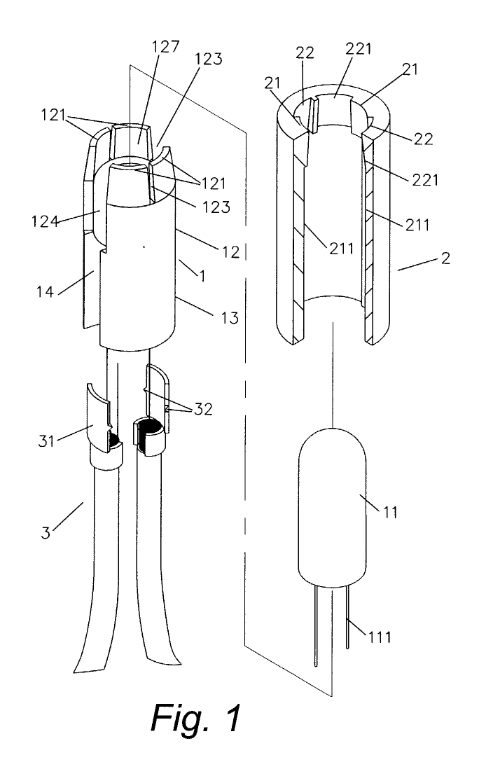

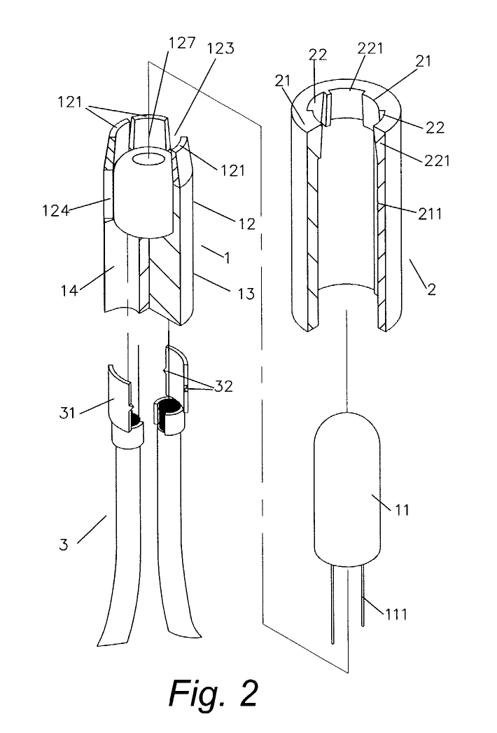

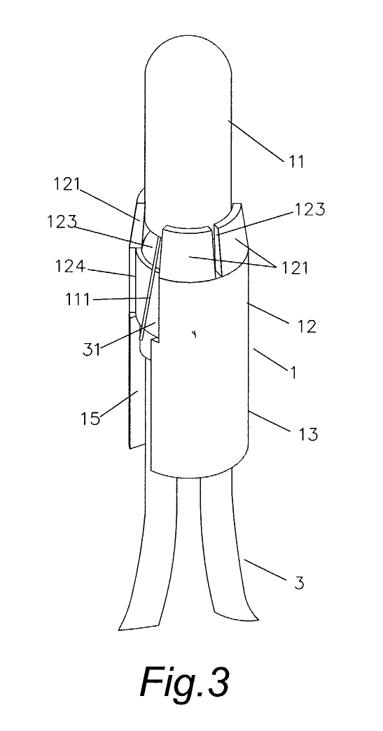

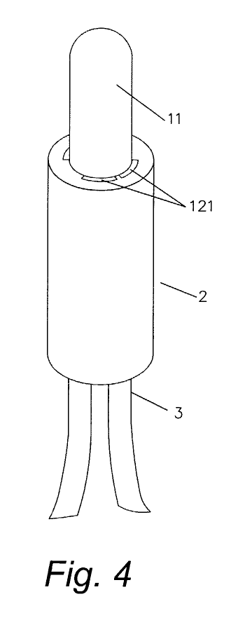

Referring to FIG. 1 to FIG. 4, the first embodiment is comprised of a bulb base and a holding sheath, wherein the bulb base 1 is a cannon consisted of two portions—upper portion 12 and low portion 13; said upper portion 12 has a bulb housing 127 at the top center, along the rim of the bulb housing 127 there is at least one pair of elastic clamping tongues 121 extended upward and tilted to the center, and the adjacent clamping tongues 121 are kept out a certain space to form a notch 123, and the diameter of the circle surrounded by the tips of the clamping tongues 121 is a bit smaller than the bulb's; below the opposite notches 123 there are a couple of retaining slots 124 formed respectively for holding said conducting strips 31, and the width of said retaining slot 124 is a bit smaller than or equal the conducting strip's 31; below the retaining slots 31 a pair of cord grooves 14 formed downward for embedding the power cords 3 respectively.

Said holding sheath 2 is a hollow cylinder with a complementary inside shape with outside shape of said bulb base 1 to form the first clamping blocks 21 with the first clamping portion 211 coordinating to the retaining slots 124 and the second clamping blocks 22 with the second clamping portion 221 coordinating to the clamping tongues 121 of the upper portion 12 of said bulb base 1; for achieving to clamping function the distance between two opposite the first clamping portions 211 should be a bit smaller than or equal the outside diameter of said retaining slots 124; the diameter surrounded by the second clamping portions 221 should be a bit smaller or equal the clamping tongue's 124.

In combination, firstly by pressing the conducting strips 31 at the tip ends of the power cords 3 into the retaining slots 124 with an extra force respectively, and embedding the cords 3 into the inside of the cord grooves 14, by means of the width of the retaining slot smaller than or equal the width of the conducting strip 31, the conducting strips 31 and cords 3 are located in place, and the barbs 311 of the conducting strips 31 have run into the side walls of the retaining slots 124 so as to fasten the conducting strips 31 in the retaining slots more stably. Then plug the bulb 11 into the bulb housing 127, simultaneously wire the wires 111 out through the notches laying over the surfaces of the conducting strips 31 respectively, in this time the bulb 11 has been clamped by the elastic clamping tongues 121 with the elastic force to keep in stable state locating in place for facilitating to put on the holding sheath 2. Finally, put on the holding sheath 2 over the assembled bulb base 1 from the up to down until they are locked together. During this process, the first clamping portions 211 slides down from the upper side to press the wires 111 of the bulb 11 to contact with the conducting strips 31 tightly; and meanwhile the second clamping portions 221 coordinating to the outside shapes of the elastic clamping tongues 121 in complementary state to press the clamping tongues 121 in all sides to the center along the tilting surfaces until completely holding up the bulb 11.

The depth of the retaining slot 124 should be proper bigger than the thickness of the conducting strip 31, so that the wire 111 of the bulb 11 is not escaped from the contacting range of the conducting strip 31 as clamping under the first clamping portion 211.

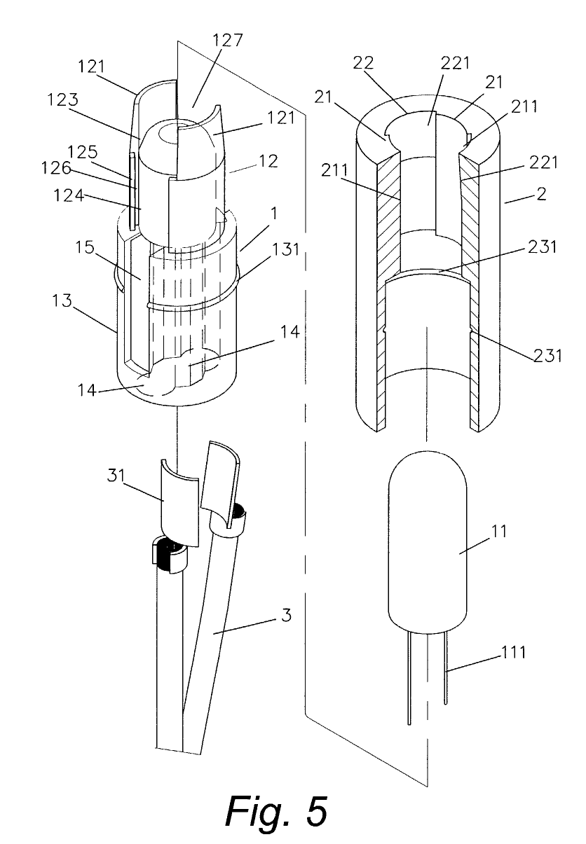

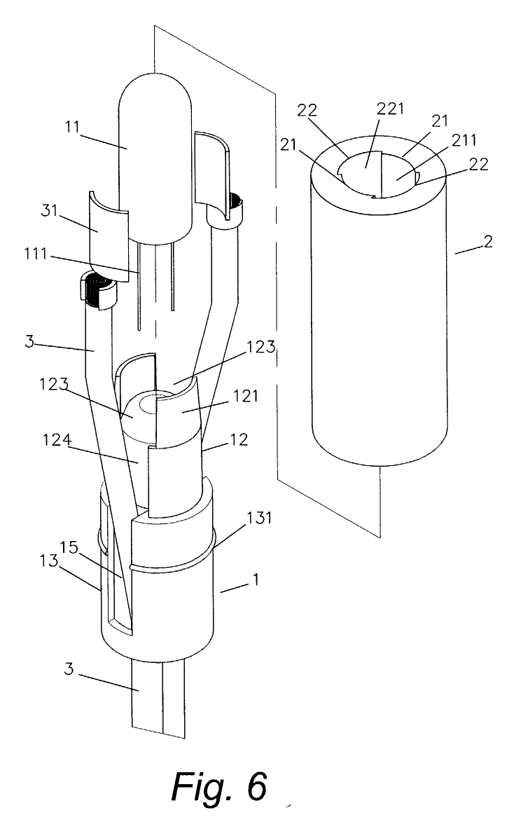

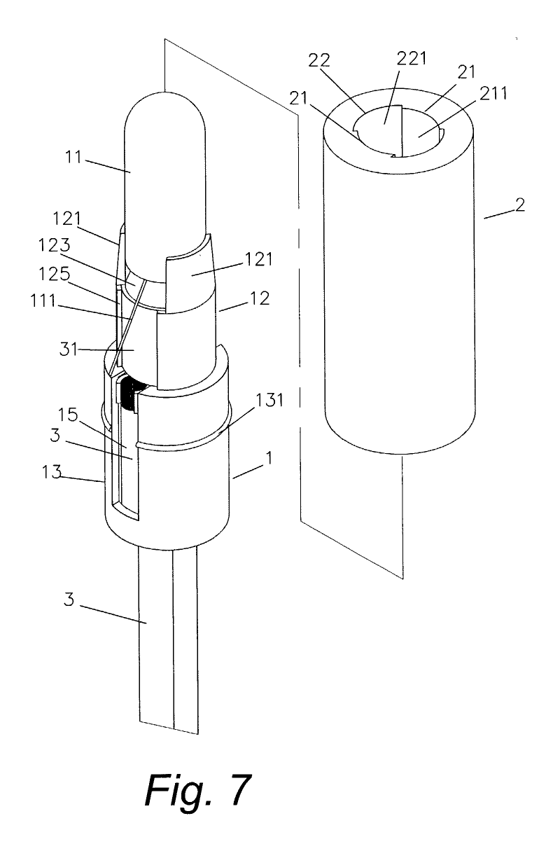

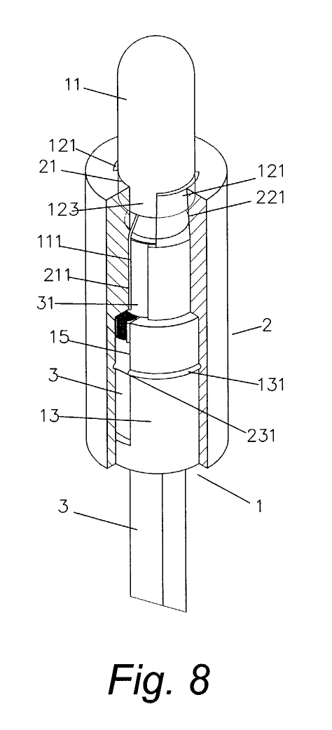

Referring to FIG. 5 to FIG. 8, the second embodiment of the present invention shown in drawings is similar with the mentioned first embodiment in structure. But wherein said retaining slots 124 has a pair of gullet teeth 125 formed at the vertical opening edges to the inside to form a sliding slot 126 for guiding the conducting strip 31 sliding into the inside of the retaining slot 124 and locating in there, or widening the top open widely to form upper wider and bottom narrower for guiding and locating the conducting strip even if the cords are dragged under an extra force, the corners and the barbs 32 of the conducting strips 31 stab into the side walls of the slot deeper so that the location is became more stably.

For resisting the horizontal dragging force, the bulb base 1 provides a central path 14 at the low portion 13, and via two side windows 15, the cords 3 and the conducting strips 31 are led out separately for locating.

For completing the joint between the bulb base 1 and the holding sheath 2, they are built upon an interlocking stopper 131 231 on the trunks of them separately.

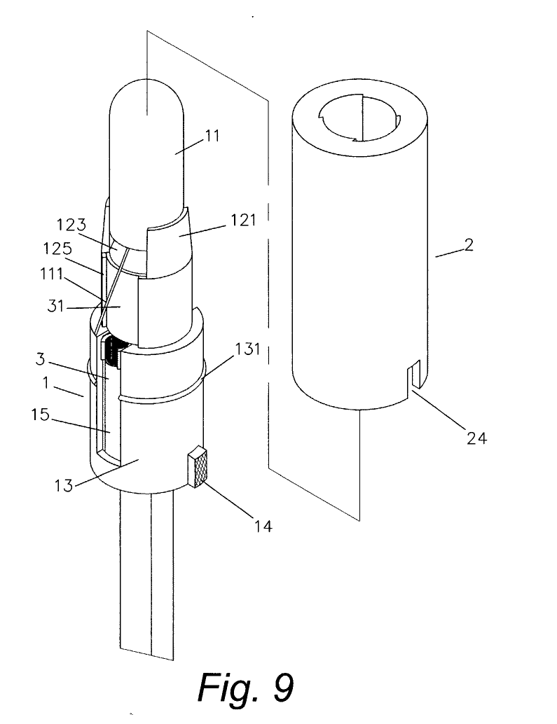

As shown in FIG. 9, the third embodiment of the present invention is similar with the mentioned first embodiment in structure. But wherein said bulb base 1 has a pair of symmetrical lugs 14 built upon the bottom side, and the holding sheath 2 has a pair of coordinating notches 24 at coordinating places for housing the lugs 14, thereby facilitating holding of hands as separating the sheath 2 and the bulb base 1.

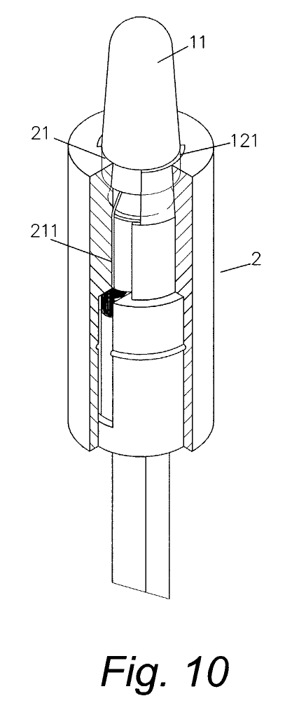

As shown in FIG. 10, the fourth embodiment of the present invention is similar with the mentioned first embodiment in structure. But wherein said bulb 11 can be shaped in bigger bottom portion for preventing it from pulling out.

I claim:

1. A Christmas decoration lamp holding frame comprised of a bulb base, a holding sheath, wherein the bulb base is a cannon consisted of two portions—upper portion and low portion; said upper portion has a bulb housing at the top center, along the rim of the bulb housing there is at least one pair of elastic clamping tongues extended upward and tilted to the center, and the adjacent clamping tongues are kept out a certain space to form a notch, and the diameter of the circle surrounded by the tips of the clamping tongues is a bit smaller than the bulb's; below the opposite notches there are a couple of retaining slots formed respectively for holding said conducting strips, and the width of said retaining slot is a bit smaller than or equal the conducting strip's; below the retaining slots a pair of cord grooves formed downward for embedding the power cords respectively; said holding sheath is a hollow cylinder with a complementary inside shape with outside shape of said bulb base to form the first clamping blocks with the first clamping portion coordinating to the retaining slots and the second clamping blocks with the second clamping portion coordinating to the clamping tongues of the upper portion of said bulb base; the distance between two opposite the first clamping portions should be a bit smaller than or equal the outside diameter of said retaining slots; the diameter surrounded by the second clamping portions should be a bit smaller or equal the clamping tongue's.

2. A Christmas decoration lamp holding frame as claimed in claim 1, wherein said cord path is built upon the center of the low portion of said bulb base, via two side radial windows at the opposite sides, the cords and the conducting strips are led out for locating on the side wall separately.

3. A Christmas decoration lamp holding frame as claimed in claim 1, wherein said retaining slots has a pair of gullet teeth formed at the vertical opening edges to the inside to form a sliding slot.

4. A Christmas decoration lamp holding frame as claimed in claim 1, wherein said retaining slot appears into wider up and narrower down between the opposite sides.

5. A Christmas decoration lamp holding frame as claimed in claim 1, wherein the depth of the retaining slot should be proper bigger than the thickness of the conducting strip.

6. A Christmas decoration lamp holding frame as claimed in claim 1, wherein between the bulb base and the holding sheath a gearing stopper is built.

7. A Christmas decoration lamp holding frame as claimed in claim 1, wherein said bulb base has a pair of symmetrical lugs built upon the bottom side, and the holding sheath has a pair of coordinating notches at coordinating places.
